(19) United States
(12) Patent Application Publication
(10) Pub. No.: US 2017/0285807 A1
(43) Pub. Date: Oct. 5, 2017

(54) Touch Display Panel, Method For Fabrication Thereof And Display Device

(71) Applicants: BOE TECHNOLOGY GROUP CO., LTD., Beijing (CN); BEIJING BOE DISPLAY TECHNOLOGY CO., LTD., Beijing (CN)

(72) Inventors: Xiaowei LIU, Beijing (CN); Yao LIU, Beijing (CN); Liangliang LI, Beijing (CN); Xiangqian DING, Beijing (CN); Jinchao BAI, Beijing (CN)

(73) Assignees: Boe Technology Group Co., Ltd., Beijing (CN); Beijing Boe Display Technology Co., Ltd., Beijing (CN)

(21) Appl. No.: 15/511,497

(22) PCT Filed: Apr. 14, 2016
(86) PCT No.: PCT/CN2016/079246

§ 371 Date: Mar. 15, 2017

(30) Foreign Application Priority Data
Jun. 5, 2015 (CN) 201510303645.7

(51) Int. Cl. G06F 3/044; G06F 3/041

(52) U.S. Cl. CPC G06F 3/044; G06F 3/0412; G06F 2203/04103; G06F 2203/04112; G06F 2203/04111

(57) ABSTRACT

The embodiments of the disclosure disclose a touch display panel, a method for fabrication thereof and a display device. The touch display panel comprises a display substrate, a transparent conductive layer formed on the display substrate, a transparent insulating layer formed on the transparent conductive layer, and a touch electrode formed on the transparent insulating layer. The embodiments of the disclosure can reduce accumulation of static electricity in the manufacture procedure of the display substrate and prevent electromagnetic interference when performing cell test by adding a transparent conductive layer and a transparent insulating layer between the touch substrate and the touch electrode.

### CROSS-REFERENCE TO RELATED APPLICATIONS

This application is a National Stage entry of PCT/CN2016/079246 filed Apr. 14, 2016, which claims the benefit and priority of Chinese patent application number 201510303645.7, filed Jun. 5, 2015. The entire disclosures of the above applications are incorporated herein by reference.

### TECHNICAL FIELD

The embodiments of the disclosure relate to a touch display panel, a method for fabrication thereof and a display device.

### BACKGROUND OF THE INVENTION

With the increasing multimedia information inquiry and the widespread use of display technique, people increasingly come into contact with products with touch screen. The touch screen has a lot of advantages of sturdy and durable, quick response, saving space, easy communication, etc. With the popularization of products such as smart phones, tablet PCs, etc., the development of touch screen technique is very fast. The current touch screen techniques are mainly OGS (One glass solution) and Oncell. The OGS technique refers to the integration of the touch screen and a protective glass. Oncell refers to embedding the touch screen between a color filter substrate and a polarizer.

FIG. 1 shows a sectional view of a current common Oncell product. The touch electrode 40 is formed by depositing directly ITO (Indium Tin Oxides) on the color film substrate 30 of the display panel, etching and forming. However, unlike the normal manufacture procedure of an array substrate, an anti-static layer cannot be deposited in advance on the back of the color film in order to prevent short circuits, because the touch electrode is formed after completing the process of color film substrate. Therefore it may easily produce static electricity in the manufacture procedure of the color film substrate, thereby affecting yield and cell test.

### SUMMARY OF THE INVENTION

The embodiments of the disclosure disclose a touch display panel, a method for fabrication thereof and a display device. Accumulation of static electricity can be reduced in the manufacture procedure of the display substrate by adding a transparent conductive layer and a transparent insulating layer between the touch substrate and the touch electrodes, thereby preventing electromagnetic interference when performing cell test.

According to the first aspect of the disclosure, there is provided a touch display panel comprising a display substrate, a transparent conductive layer formed on the display substrate, a transparent insulating layer formed on the transparent conductive layer, and a touch electrode formed on the transparent insulating layer.

According to an embodiment of the disclosure, wherein the transparent conductive layer and/or the transparent insulating layer are/is an anti-reflection film.

According to an embodiment of the disclosure, wherein the refractive index of the transparent conductive layer is greater than the refractive index of the display substrate and is less than the refractive index of the transparent insulating layer.

According to an embodiment of the disclosure, wherein the refractive index of the transparent conductive layer conforms to the following formula:

n₁=\sqrt{n₀n₂}

wherein n₁ is the refractive index of the transparent conductive layer, n₂ is the refractive index of the transparent insulating layer, and n₀ is the refractive index of the display substrate.

According to an embodiment of the disclosure, the optical thickness of the transparent conductive layer is odd times of a quarter of the wavelength of light incident to the transparent conductive layer.

According to an embodiment of the disclosure, the transparent insulating layer consists of multiple transparent insulating films with different refractive indexes, and the thickness of the transparent conductive layer and the thickness of each of the multiple transparent insulating films are obtained by computation by way of an interference matrix.

According to an embodiment of the disclosure, wherein the refractive index of each transparent insulating film of the transparent insulating layer decreases gradually in the direction close to the transparent conductive layer.

According to another aspect of the disclosure, there is disclosed a method for fabricating a touch display panel. The method comprises:

forming a transparent conductive layer on a display substrate;

forming at least one insulating layer on the transparent conductive layer;

forming a touch electrode on the at least one insulating layer.

According to an embodiment of the disclosure, the refractive index of the transparent conductive layer is greater than the refractive index of the display substrate and is less than the refractive index of the transparent insulating layer.

According to an embodiment of the disclosure, the refractive index of the transparent conductive layer conforms to the following formula:

n₁=\sqrt{n₀n₂}

wherein n₁ is the refractive index of the transparent conductive layer, n₂ is the refractive index of the transparent insulating layer, and n₀ is the refractive index of the display substrate.

According to an embodiment of the disclosure, the optical thickness of the transparent conductive layer is odd times of a quarter of the wavelength of light incident to the transparent conductive layer.

According to an embodiment of the disclosure, forming at least one insulating layer on the at least one insulating layer comprises: forming multiple overlay transparent insulating films with different refractive indexes on the transparent conductive layer.

According to an embodiment of the disclosure, the refractive index of each transparent insulating film decreases gradually in the direction close to the transparent conductive layer.

According to still another aspect of the disclosure, there is provided a display device comprising the above touch display panel.

The touch display panel, the method for fabrication thereof and the display device according to embodiments of the disclosure can mitigate the issue of accumulation of static electricity in the manufacture procedure of the display panel, reduce signal crosstalk between a touch signal and TFT signal, and increase the transmissivity and contrast of product under bright light, by adding a transparent conductive layer and a transparent insulating layer with anti-reflection effect between the touch substrate and the touch electrodes. In addition, it is provided the transparent insulating layer with multiple films structure which can realize multilayer anti-reflection effect and achieve the purpose of anti-reflection for wide spectrum.

### BRIEF DESCRIPTION OF THE DRAWINGS

FIG. 1 shows a schematic structure diagram of a touch display panel in the prior art.

FIG. 2 shows a schematic structure diagram of a touch display panel according to an embodiment of the disclosure.

FIG. 3 shows a schematic diagram of the principle of anti-reflection of a transparent conductive layer according to an embodiment of the disclosure.

FIG. 4 shows a diagram of emission spectrum of single anti-reflection film according to an embodiment of the disclosure;

FIG. 5 shows a diagram of emission spectrum of double anti-reflection films according to an embodiment of the disclosure.

FIG. 6 shows a diagram of emission spectrum of multiple anti-reflection films according to an embodiment of the disclosure.

FIG. 7 is a schematic structure diagram of a touch display panel according to another embodiment of the disclosure.

FIG. 8 is a flow chart of a method for fabricating a touch display panel according to an embodiment of the disclosure.

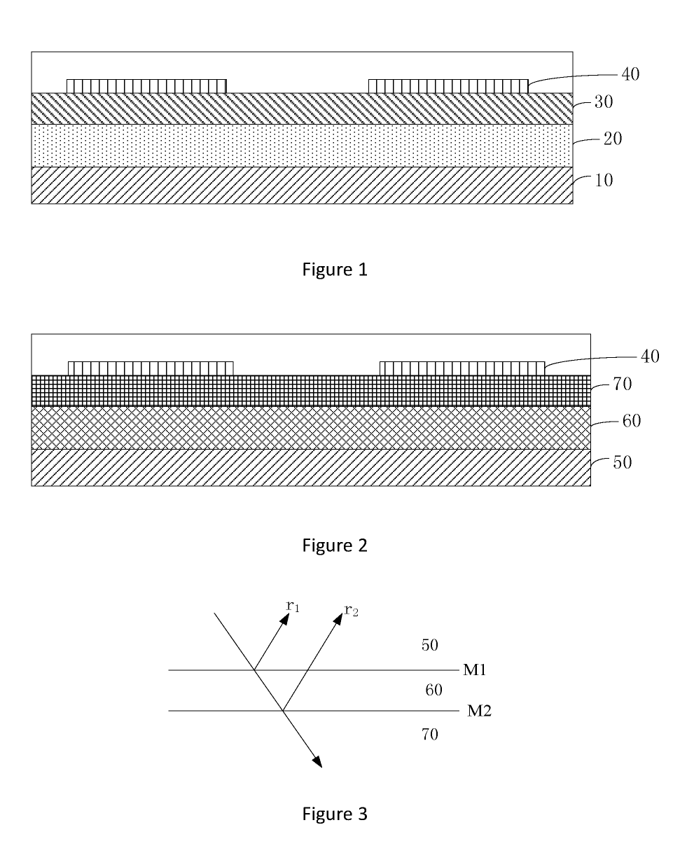

### DETAILED DESCRIPTION OF SPECIFIC EMBODIMENTS

The technical solutions of embodiments of the present disclosure will be described below in connection with the accompanying drawings and embodiments. The described embodiments are only used to illustrate the technical solutions of the present disclosure more clearly rather than limit the protect scope of the disclosure.

There is provided a touch display panel in an embodiment of the present disclosure.

FIG. 2 shows a schematic structure diagram of a touch display panel according to an embodiment of the disclosure.

With reference to FIG. 2, the touch display panel of the embodiment comprises:

a display substrate 50, a transparent conductive layer 60 formed on the display substrate 50, a transparent insulating layer 70 formed on the transparent conductive layer 60, and a touch electrode 40 formed on the transparent insulating layer 70. The display substrate 50 may be any suitable existing or future display substrate.

The embodiment of the present disclosure can reduce signal interference between a touch signal and thin film transistor and increase the stability of the touch display panel by providing the transparent conductive layer 60 and the transparent insulating layer 70 between the touch substrate 50 and the touch electrode 40, wherein the transparent conductive layer 60 can play the role of electrostatic protection and the transparent insulating layer 70 can insulate the transparent conductive layer from the touch electrode 40.

In the above embodiment, the transparent conductive layer 60 and/or the transparent insulating layer 70 is an anti-reflection film which can increase the light transmissivity.

In addition, in order to achieve anti-reflection effect, the refractive index n₁ of the transparent conductive layer 60 is greater than the refractive index n₀ of the display substrate 50 and is less than the refractive index n₂ of the transparent insulating layer 70. In generally, the refractive index n₀ of the display substrate 50 as used herein can be considered as the refractive index of a layer of the display substrate 50, wherein the layer of the display substrate 50 is adjacent to the transparent conductive layer 60.

Based on the principle of anti-reflection and when the transparent conductive layer 60 being an anti-reflection film, as shown in FIG. 3, reflected light r₁ may be produced at the interface M1 between the display substrate 50 and the transparent conductive layer 60 and reflected light r₂ may be produced at the interface M2 between the transparent conductive layer 60 and the transparent insulating layer 70 when incident light is incidence to the transparent conductive layer 60 from the display substrate 50, passes through the transparent conductive layer 60 and is incidence to the transparent insulating layer 70. r₁ and r₂ may occur destructive interference when 2 n₁d=(k+½)λ and k=0,1,2 . . . , i.e., the optical thickness n₁d of the transparent conductive layer 60 is odd times of a quarter of the wavelength of light incident to the transparent conductive layer 60, thereby causing the transparent conductive layer 60 to increase light transmissivity and reduce light reflectivity.

In addition, based on the above interference formula, when n₁=n₀n₂, the interference effect is the best, i.e., the anti-reflection effect is the best.

Moreover the arrangement of the transparent insulating layer 70 is based on the above principle, which can achieve the anti-reflection effect of the transparent insulating layer 70 and achieve the double layer films' anti-reflection effect of the transparent conductive layer 60 and the transparent insulating layer 70.

In another embodiment, the transparent insulating layer 70 consists of multiple transparent insulating films with different refractive indexes, and the thickness of each of the multiple transparent insulating films may be obtained by calculation based on the above principle of anti-reflection. In addition, the thickness of the transparent conductive layer and the thickness of the transparent insulating layer may be obtained by calculation through establishing the interference matrix.

Based on the structure of the transparent insulating layer 70 with multiple transparent insulating films according to the above embodiment, the refractive index of each transparent insulating film of the transparent insulating layer decreases gradually in the direction close to the transparent conductive layer 60 such that multilayer anti-reflection effect can be achieved.

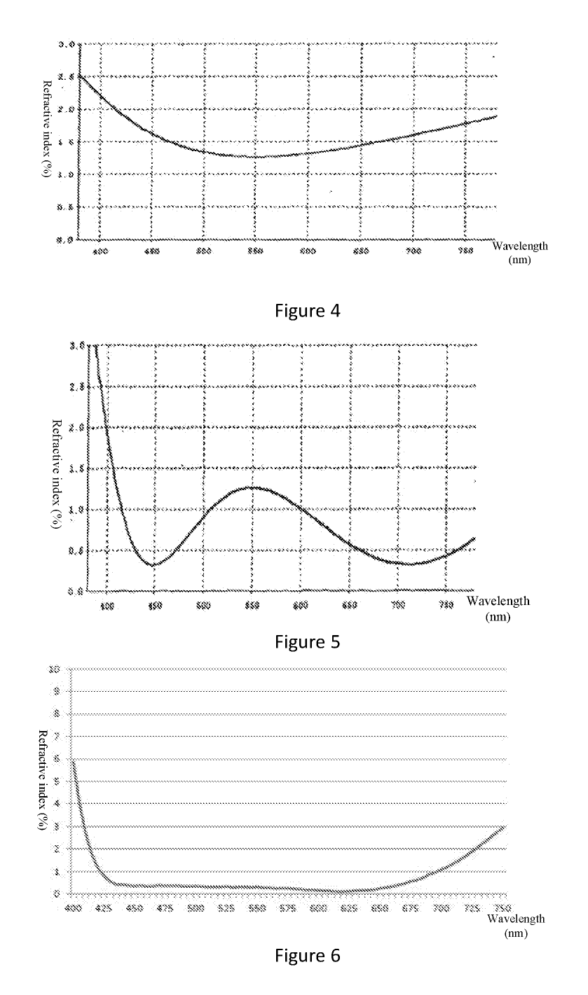

FIG. 4 shows a diagram of emission spectrum of single anti-reflection film. As shown in FIG. 4, in a case of natural light passes through the single anti-reflection film, the reflectivity of light with about 550 nm wavelength is the minimum. Therefore the single anti-reflection film has a good anti-reflection effect for light with a certain wavelength or within a small waveband range.

FIG. 5 shows a diagram of emission spectrum of double anti-reflection films. As shown in FIG. 5, by using the double anti-reflection films, the reflectivities of visible light with 450 nm waveband and near-infrared light with 700 nm waveband are the minimum. Therefore the narrowband anti-reflection effect can be achieved by using the double anti-reflection films.

FIG. 6 shows a diagram of emission spectrum of multiple anti-reflection films. As can been seen from FIG. 6, the anti-reflection effect for light within a wider spectral region can be achieved by using the multiple anti-reflection films. The anti-reflection effect for the multilayer film can be achieved by arranging both the transparent conductive layer and the transparent insulating layer as anti-reflection films and arranging the transparent insulating layer as the multilayer film in the embodiment of the present disclosure. Therefore the anti-reflection effect can be achieved for light within visible light range, and the light transmissivity can be increased.

In the above embodiment, the transparent conductive layer 60 may be an ITO thin film, and the transparent insulating layer 70 may be SiNx thin film. The ITO film is a kind of semiconductor film, wherein the complex refractive index of the semiconductor has a higher K (dielectric constant) value at infrared waves and the higher K value can cause the semiconductor to have high reflectivity at the infrared waves, while the reflection of free carrier can shield electromagnetic wave so that the purpose of electromagnetic shield can be achieved. In addition, the above two kinds of thin films can be fabricated in the existing display panel production line, thereby avoiding the extra costs caused by adding additional devices. Moreover, the materials of the transparent conductive layer 60 and the transparent insulating layer 70 are not limited to the above materials, but the other materials with the similar function may be used to make the transparent conductive layer and the transparent insulating layer according to the embodiments.

In addition, the display substrate according to the embodiments may be any of various display panels in the prior art or a composition substrate thereof or a substrate of the composition substrate, for example, it can be a liquid crystal display panel or a substrate of the color film substrate or other type of display substrate.

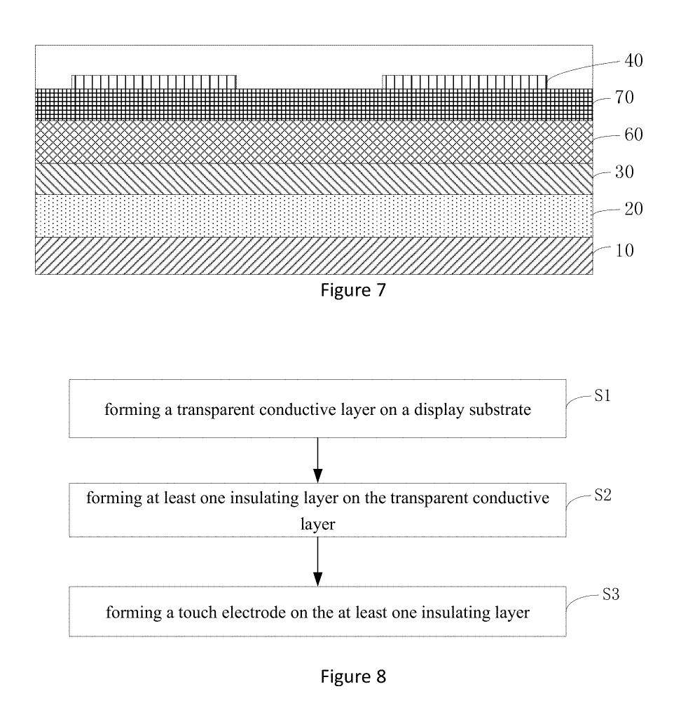

In another embodiment of the disclosure, as shown in FIG. 7, the touch display panel may comprise:

an array panel 10, a liquid crystal layer 20, a color film substrate 30, a transparent conductive layer 60 and a transparent insulating layer 70 which are provided on the color film substrate 30 and away from a light filter layer, and a touch electrode 40 provided on the transparent insulating layer 70.

In the embodiment, the transparent conductive layer 60 and the transparent insulating layer 70 with anti-reflection effect are provided on the color film substrate 30, which can not only avoid accumulation of static electricity in the manufacture procedure of the color film substrate 30 and prevent electromagnetic interference when performing cell test, but also can increase the transmissivity of the touch display panel and reduce ambient light reflectivity thereof, thereby increasing the transmissivity and contrast of the touch display panel under bright light, reducing signal crosstalk between the touch signal and the display substrate signal and increasing the stability of the touch signal.

According to another embodiment of the disclosure, there is disclosed a method for fabricating a touch display panel. As shown in FIG. 8, the method comprises:

S1: forming a transparent conductive layer on a display substrate;

S2: forming at least one insulating layer on the transparent conductive layer; and

S3: forming a touch electrode on the at least one insulating layer.

It may be understood by those skilled in the art that the display substrate may be an OLED panel or a liquid crystal panel after cell process or a substrate of the color film substrate. When the display substrate is the substrate of the color film substrate, there may be a following step between S1 and S2: forming a light filter layer on the other side of the display substrate. There may be a following step between S2 and S3: performing cell process on the display substrate.

In addition, the above step S3 may comprise:

forming the touch electrode above the transparent insulating layer of the display substrate by depositing transparent conductive materials and forming a pattern and lines.

In a further embodiment, the refractive index of the materials used for forming the transparent conductive layer is greater than that of the display substrate and is less than that of the materials used for forming the transparent insulating layer.

In another embodiment, the refractive index of the materials used for forming the transparent conductive layer conforms to the following formula:

n₁=\sqrt{n₀n₂}

wherein n₁ is the refractive index of the transparent conductive layer, n₂ is the refractive index of the transparent insulating layer, and n₀ is the refractive index of the display substrate. In generally, the refractive index n₀ of the display substrate as used herein can be considered as the refractive index of a layer of the display substrate which is adjacent to the transparent conductive layer.

In another embodiment, in order to achieving the anti-reflection function of the transparent conductive layer, the optical thickness of the transparent conductive layer is odd times of a quarter of the wavelength of light incident to the transparent conductive layer.

In another embodiment, forming at least one insulating layer on the transparent conductive layer may further comprise: forming multiple overlay transparent insulating films with different refractive indexes on the transparent conductive layer, wherein the refractive index of each transparent insulating film of the transparent insulating layer decreases gradually in the direction close to the transparent conductive layer. This kind of multilayer films structure can achieve the anti-reflection effect of multilayer films, thereby achieving the anti-reflection effect for wide spectrum.

In still another embodiment of the disclosure, there is provided a display device comprising the above touch display panel.

The touch display panel, the method for fabrication thereof and the display device according to embodiments of the disclosure can mitigate the issue of accumulation of static electricity in the manufacture procedure of the display panel in the prior art, reduce signal crosstalk between the touch signal and the TFT signal, and increase the stability of the touch display panel, by adding a transparent conductive layer and a transparent insulating layer with anti-reflection effect between the touch substrate and the touch electrodes. Meanwhile, the transmissivity and contrast of the product under bright light can be increased by using the film structure with anti-reflection effect. In addition, the transparent insulating layer is arranged as the multilayer films structure which can achieve multilayer anti-reflection effect, thereby achieving the purpose of the anti-reflection effect for wide spectrum.

The above embodiments are only some embodiment of the disclosure. It is noted that many modifications and variations can be made by those ordinary skilled in the art without departing from the technical principle of the disclosure, which are within the protect scope of the disclosure.

1. A touch display panel, comprising:
a display substrate, a transparent conductive layer formed on the display substrate, a transparent insulating layer formed on the transparent conductive layer, and a touch electrode formed on the transparent insulating layer.

2. The touch display panel according to claim 1, wherein the transparent conductive layer and/or the transparent insulating layer are/is an anti-reflection film.

3. The touch display panel according to claim 1, wherein the refractive index of the transparent conductive layer is greater than the refractive index of the display substrate and is less than the refractive index of the transparent insulating layer.

4. The touch display panel according to claim 1, wherein the refractive index of the transparent conductive layer conforms to the following formula:
n₁=\sqrt{n₀n₂}
wherein n₁ is the refractive index of the transparent conductive layer, n₂ is the refractive index of the transparent insulating layer, and n₀ is the refractive index of the display substrate.

5. The touch display panel according to claim 1, wherein the optical thickness of the transparent conductive layer is odd times of a quarter of the wavelength of light incident to the transparent conductive layer.

6. The touch display panel according to claim 1, wherein the transparent insulating layer consists of multiple transparent insulating films with different refractive indexes, and the thickness of the transparent conductive layer and the thickness of each of the multiple transparent insulating films are obtained by computation by way of an interference matrix.

7. The touch display panel according to claim 6, wherein the refractive index of each transparent insulating film of the transparent insulating layer decreases gradually in the direction close to the transparent conductive layer.

8. A method for fabricating a touch display panel, comprising:
forming a transparent conductive layer on a display substrate;
forming at least one insulating layer on the transparent conductive layer; and
forming a touch electrode on the at least one insulating layer.

9. The method according to claim 8, wherein the refractive index of the transparent conductive layer is greater than the refractive index of the display substrate and is less than the refractive index of the transparent insulating layer.

10. The method according to claim 8, wherein the refractive index of the transparent conductive layer conforms to the following formula:
n₁=\sqrt{n₀n₂}
wherein n₁ is the refractive index of the transparent conductive layer, n₂ is the refractive index of the transparent insulating layer, and n₀ is the refractive index of the display substrate.

11. The method according to claim 8, wherein the optical thickness of the transparent conductive layer is odd times of a quarter of the wavelength of light incident to the transparent conductive layer.

12. The method according to claim 8, wherein forming at least one insulating layer on the transparent conductive layer comprises: forming multiple overlay transparent insulating films with different refractive indexes on the transparent conductive layer.

13. The method according to claim 12, wherein the refractive index of each transparent insulating film decreases gradually in the direction close to the transparent conductive layer.

14. A display device comprising the touch display panel according to claim 1.

15. The touch display panel according to claim 2, wherein the refractive index of the transparent conductive layer is greater than the refractive index of the display substrate and is less than the refractive index of the transparent insulating layer.

16. The touch display panel according to claim 2, wherein the refractive index of the transparent conductive layer conforms to the following formula:
n₁=\sqrt{n₀n₂}
wherein n₁ is the refractive index of the transparent conductive layer, n₂ is the refractive index of the transparent insulating layer, and n₀ is the refractive index of the display substrate.

17. The touch display panel according to claim 3, wherein the refractive index of the transparent conductive layer conforms to the following formula:
n₁=\sqrt{n₀n₂}
wherein n₁ is the refractive index of the transparent conductive layer, n₂ is the refractive index of the transparent insulating layer, and n₀ is the refractive index of the display substrate.

18. The touch display panel according to claim 2, wherein the optical thickness of the transparent conductive layer is odd times of a quarter of the wavelength of light incident to the transparent conductive layer.

19. The touch display panel according to claim 3, wherein the optical thickness of the transparent conductive layer is odd times of a quarter of the wavelength of light incident to the transparent conductive layer.

20. The touch display panel according to claim 4, wherein the optical thickness of the transparent conductive layer is odd times of a quarter of the wavelength of light incident to the transparent conductive layer.
